(19) United States
(12) Patent Application Publication
(10) Pub. No.: US 2001/0007250 A1
(43) Pub. Date: Jul. 12, 2001

(54) Idle speed control devices

(76) Inventors: Yasuhiko Hattori, Obu-shi (JP); Takayoshi Amano, Obu-shi (JP); Koichi Shimizu, Toyota-shi (JP); Satoshi Uematsu, Toyota-shi (JP)

Correspondence Address: DENNISON, SCHEINER,, SCHULTZ & WAKEMAN, 612 Crystal Square 4, 1745 Jefferson Davis Highway, Arlington, VA, 22202-3417, US

(21) Appl. No.: 09/752,559

(22) Filed: Jan. 3, 2001

(30) Foreign Application Priority Data
Jan. 7, 2000 (JP) 2000-1867

(51) Int. Cl. F02M 35/10

(52) U.S. Cl. 123/339.1; 123/339.13

(57) ABSTRACT

A throttle valve (12) is provided in an intake air passage (11) of a throttle body (10) and serves to control the air flows rate that is supplied into a combustion chamber of an internal combustion engine. A valve housing (21) is joined to the throttle body (10). A communication passage (22) is formed in the valve housing (21). A branching side passage (13a) and a joining side passage (13b) are formed in the throttle body 10 and, together with the communication passage (22) in the valve housing (21), form a bypass structure (13) that bypass the throttle valve (12). A valve seat portion (23) is formed on the valve housing (21) in the communication passage (22). A valve (25) is provided in the valve housing (21) and serves to control the opening area of the valve seat portion (23). A lattice (50) is disposed downstream of the valve seat portion (23) in the bypass structure (13). The lattice (50) may be replaced with other structures adapted to reduce or prevent turbulent airflow downstream of the valve seat portion (23). Preferably, such structure generates a laminar airflow.

### BACKGROUND OF THE INVENTION

1. Field of the Invention

The present invention relates to idle speed control devices for controlling the rate of airflow to an internal combustion engine while the internal combustion engine is idling.

Preferably, such idle speed control devices may be used in vehicles.

2. Description of the Related Art

A known idle speed control device is disclosed, for example, in Japanese Laid Open Patent Publication No. 1-92541. FIG. 11 is a sectional view illustrating the relationship between a throttle body 110 and the known idle speed control device 120 of this publication. The throttle body 110 defines an intake air passage 111 through which air (intake air) is fed into a combustion chamber of an internal combustion engine for a vehicle. Intake air flows from the right to the left as viewed in FIG. 11 (in the direction shown by arrow Y1 in FIG. 11). A throttle valve 112 is pivotally disposed within the throttle body 110 and serves to control the air flow rate through the intake air passage 111 into the combustion chamber of the internal combustion engine.

Further, a bypass structure 113 is formed in the throttle body 110 in a manner to provide a communication path that bypasses the throttle valve 112. For example, when the throttle valve 112 is fully closed (or in a state in which the opening is minimized) while the internal combustion engine is idling, air is supplied into the combustion chamber of the internal combustion engine through the bypass structure 113 (in the direction shown by arrow Y2 in FIG. 11). The idle speed control device 120 is mounted on the throttle body 110 and can be adjusted to control the airflow rate through the bypass structure 113.

The known idle speed control device 120 will now be explained in further detail with reference to FIG. 12. The idle speed control device 120 has a valve housing 120 that is joined to the throttle body 110. Further, a communication passage 122 is formed in the valve housing 121 and communicates with the bypass structure 113. A valve seat portion 123 is formed on the valve housing 121 in the middle of the communication passage 122. A valve seat surface 123a is formed upstream of the valve seat portion 123.

A valve shaft 124 is rotatably mounted within the valve housing 121 and a valve 125 is integrally formed with the valve shaft 124. The valve 125 pivots by sliding across the valve seat surface 123a of the valve housing 121 and thereby controls the cross-sectional area (opening area) of the air passage defined by the valve seat portion 123. A rotary solenoid actuator (not shown) drives the valve shaft 124.

In the known idle speed control device 120, the actuator rotates the valve shaft 124 and the integral valve 125 while the engine is idling. Thus, the airflow rate that is supplied into the combustion chamber of the engine through the bypass structure 113 is controlled by changing the pivotal position of the valve 125.

### SUMMARY OF THE INVENTION

However, the known idle speed control device 120 generates a turbulent airflow downstream of the valve seat portion 123 (e.g. at portion X in FIG. 12). As a result, hissing noises (airflow noises) are generated within the idle speed control device 120 and the throttle body 110.

It is, accordingly, an object of the present teachings to teach improved idle speed control devices. In one aspect of the present teachings, idle speed control devices are taught that reduce or prevent turbulent airflow from being generated on the downstream side of the idle speed control device. As a result, noises generated by turbulent air flow downstream of a valve seat portion that is provided in a bypass structure of the idle speed control device can be reduced or eliminated.

In one embodiment of the present teachings, a lattice is disposed downstream of the valve seat portion. Thus, if turbulent airflow is generated through the valve seat portion, the lattice diffuses the turbulent air flowing through the bypass structure. Thus, turbulent airflow is reduced or eliminated and the idle speed control device may operate more quietly. Preferably, the lattice may be disposed between a throttle body, in which a throttle valve is disposed, and a valve housing in which a valve is disposed.

In another embodiment of the present teachings, a gasket may be provided between the throttle body and the valve housing. The gasket may be integrally formed with the lattice.

Additional objects, features and advantages of the present invention will be readily understood after reading the following detailed description together with the accompanying drawings and the claims.

### BRIEF DESCRIPTION OF THE DRAWINGS

FIG. 1 is a sectional side view of an idle speed control device according to a first representative embodiment of the present teaching, which is shown mounted on a throttle body;

FIG. 2 is a sectional plan view of the idle speed control device of the first representative embodiment;

FIG. 3 is a plan view of a gasket;

FIG. 4 is a plan view of a lattice;

FIG. 5 is a partially enlarged view of circled portion V shown in FIG. 3;

FIG. 6 is a sectional view taken along line VI-VI shown in FIG. 5;

FIG. 7 is a sectional view taken along line VII-VII shown in FIG. 3;

FIG. 8 is a sectional view of the gasket in an assembled state;

FIG. 9 is another sectional view of the gasket in an assembled state;

FIG. 10 is a graph showing a comparison between the known idle speed control device and an idle speed control device of the present teachings with respect o sound frequency and sound pressure level;

FIG. 11 shows a known idle speed control device and throttle body; and

FIG. 12 is a sectional side view of the known idle speed control device.

### DETAILED DESCRIPTION OF THE INVENTION

The present specification teaches techniques and designs for reducing or eliminating turbulent airflow from being generated by an idle speed control device.

Preferably, the idle speed control device is capable of supplying a laminar, or substantially laminar, airflow to the internal combustion engine. Various structures may be utilized in order to achieve this object and thereby reduce noise generated by an idle speed control device while the internal combustion engine is idling.

In one example of the present teachings, a throttle body may be provided to supply appropriate amounts of air to an internal combustion engine during normal operation. A throttle valve may be provided in an intake air passage of the throttle body in order to control the amount of air that is supplied to the internal combustion engine. However, during idling, the throttle valve may close, or substantially close the intake air passage and air may be supplied to the internal combustion engine via a bypass structure that is disposed proximally to the throttle body. An idle speed control device may be provided within the bypass structure in order to control the airflow rate during idling.

The idle speed control device may include, for example, a valve seat portion and a valve. In one representative embodiment, the valve may be rotated or pivoted in order to control the opening area of the valve seat portion. Preferably, the idle speed device may further include a structure that reduces or eliminates turbulent airflow from being supplied to the throttle body during idling. This structure may, more preferably, provide a laminar airflow, or a substantially laminar airflow.

In one embodiment of the present teachings, a lattice may be disposed downstream of the valve seat portion. The lattice may serve to reduce or eliminate turbulent airflow that has been generated by passing air through the valve seat portion. Thus, noises that are caused by turbulent airflow can be reduced.

In another embodiment of the present teachings, the idle speed control may be coupled to the throttle body. Preferably, the intake air passage and the throttle valve are disposed within the throttle body. The turbulent airflow reducing structure (e.g. a lattice) may be disposed, for example, between the throttle body and the valve housing of the idle speed control device. In this embodiment, because the lattice is installed downstream of the valve seat portion, special components for installing the lattice are not required.

In another embodiment of the present teachings, a gasket may be disposed between the valve housing and the throttle body in order to provide a tight seal. The turbulent airflow reducing structure (e.g. a lattice) may be integrally formed with the gasket. In this embodiment, because the lattice is integrally formed with the gasket, the lattice can be installed downstream of the valve seat portion by installing the gasket.

The bypass structure of the idle speed control device may include, for example, a branching side passage and a joining side passage that are formed in the throttle body. In addition, a communication passage may be formed in the valve housing to permit the branching side passage to communicate with the joining side passage. In this case, the gasket can be easily mounted if only one gasket is provided to seal the clearance between the throttle body and the valve housing on both sides of the branching side passage and the joining side passage. In this respect, the gasket may preferably have a generally figure-8 shape and the lattice may be integrally formed on a portion of the gasket that faces the joining side passage.

If the lattice is integrally formed with the gasket, a preferred joining method may be used to securely join the lattice to the gasket. For example, a plurality of projections may be formed on the outer peripheral edge portion of the lattice. Each of the projections may have a through hole and a portion of the gasket is fitted into the through holes of the projections. Thus, the lattice can be securely joined to the gasket.

In another embodiment, the gasket may have an annular portion and a groove may be formed in either one of the throttle body or the valve housing. The groove is preferably adapted to receive the annular portion of the gasket. With this construction, a tight seal can be provided between the throttle body and the valve housing.

Further, a support piece may preferably be formed on and along the inner periphery of the annular portion of the gasket. A stepped surface may be formed on and along the inner peripheral portion of the groove in the either one of the throttle body or the valve housing.

The stepped surface may contact the support piece. With this construction, a tight seal can be provided between the throttle body and the valve housing. Moreover, the lattice can be reliably disposed between the throttle body and the valve housing.

Each of the additional features disclosed above and below may be utilized separately or in conjunction with other features to provide improved idle speed control devices. Representative examples of the present invention, which examples utilize many of these additional features in conjunction, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features disclosed in the following detail description may not be necessary to practice the invention in the broadest sense, and are instead taught merely to particularly describe some representative examples of the invention. Moreover, various features of the representative examples may be combined in ways that are not specifically enumerated in order to provide additional useful embodiments of the present teachings.

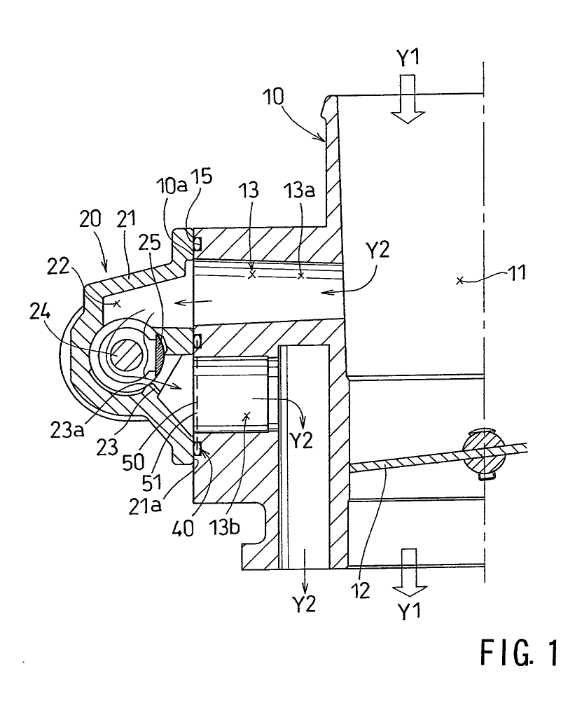

FIG. 1 is a sectional side view of a representative idle speed control device 20, which is shown mounted on a throttle body 10. The throttle body 10 will be explained before the idle speed control device 20.

An intake air passage 11 is formed in the throttle body 10, and air (intake air) is supplied through the intake air passage 11 into a combustion chamber (not shown) of an internal combustion engine for a vehicle. Intake air flows from top to bottom as viewed in FIG. 1 (in the direction shown by arrow Y1). A throttle valve 12 is pivotally mounted within the throttle body 10 and serves to open and close the intake air passage 11. The air flow rate that is supplied into the combustion chamber of the internal combustion engine through the intake air passage 11 is controlled by changing the pivotal position of the throttle valve 12.

A branching side passage 13a and a joining side passage 13b are formed in the throttle body 10 and form a bypass structure 13 that provides a bypass path to the throttle valve 12. The branching side passage 13a is linearly formed upstream of the throttle valve 12 in a manner to branch out from the intake air passage 11 toward the outside surface of the throttle body 10. The joining side passage 13b extends from below the branching side passage 13a at the outside surface of the throttle body 10 and is generally L-shaped so as to join with the intake air passage 11 downstream of the throttle valve 12.

The throttle valve 12 is typically fully closed while the internal combustion engine is idling. At this time, air is supplied into the combustion chamber of the engine through the bypass structure 13 (in the direction shown by arrow Y2 in FIG. 1). The idle speed control device 20 is mounted on the side surface of the throttle body 10 and serves to control the rate of air flowing through the bypass structure 13.

A joining surface 10a is formed on the side surface of the throttle body 10 and a valve housing 21 of the idle speed control device 20 is joined to the joining surface 10a.

Open end surfaces of the branching side passage 13a and the joining side passage 13b are formed on the joining surface 10a. A groove 15 is formed in the joining surface 10a and has a generally figure-8 shape that surrounds the open end surfaces of the branching side passage 13a and the joining side passage 13b.

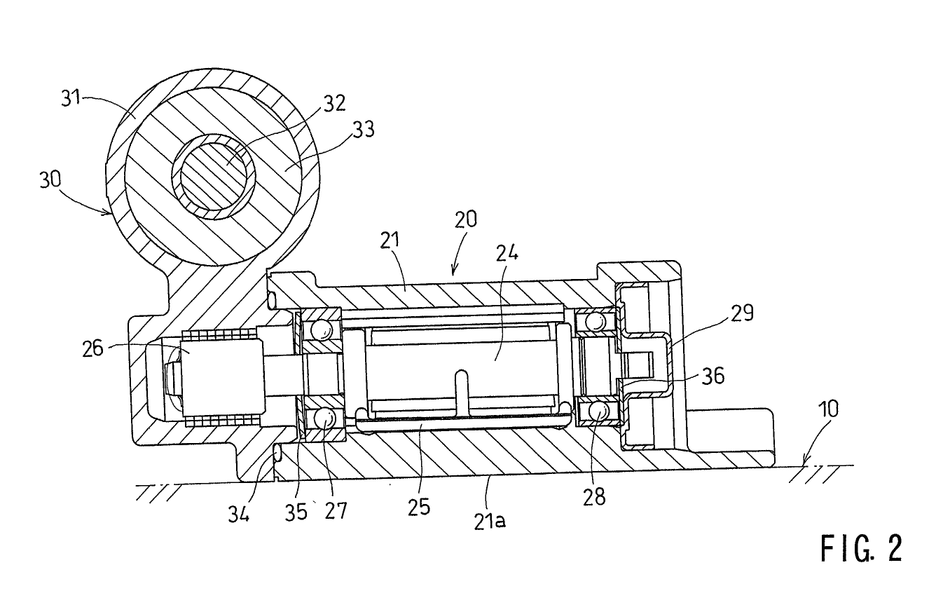

A gasket 40 is fitted in the groove 15 of the throttle body 10. In this embodiment, the gasket 40 comprises an elastic rubber material and has a generally figure-8 shape. When the idle speed control device 20 is joined to the throttle body 10, the gasket 40 elastically deforms and thereby seals the clearance between the throttle body 10 and the valve housing 21. 30 The idle speed control device 20 will now be explained. As shown in FIG. 1, a joining surface 21a of the valve housing 21 is coupled to the joining surface 10a of the throttle body 10. In this state, the idle speed control device 20 may be secured to the throttle body 10 using a known fastening structure (not shown). FIG. 2 is a sectional plan view of the idle speed control device 20.

A communication passage 22 is formed in the valve housing 21 and permits the branching side passage 13a to communicate with the joining side passage 13b. The communication passage 22 is generally C-shaped such that the upper and lower open end surfaces are open to the joining surface 21a. The upper open end surface of the communication passage 22 communicates with the open end surface of the branching side passage 13a of the throttle body 10. Likewise, the lower open end surface of the communication passage 22 communicates with the open end surface of the joining side passage 13b of the throttle body 10. The communication passage 22 of the valve housing 21 and the branching side passage 13a and the joining side passage 13b of the throttle body 10 form the bypass structure 13 in this particular embodiment.

A valve seat portion 23 is formed on the valve housing 21 in the middle of the communication passage 22. A valve seat surface 23a is formed on the upstream side of the valve seat portion 23.

As shown in FIG. 2, a valve shaft 24 is rotatably supported by a pair of right and left bearings 27 and 28 disposed within the valve housing 21. A generally U-shaped valve 25 is integrally formed in the generally middle portion of the valve shaft 24. The valve 25 pivots while slidingly contacting the valve seat surface 23a of the valve housing 21. The cross2 sectional area (opening area) of the passage within the valve seat portion 23 is controlled by adjusting the pivotal position of the valve 25.

An actuator 30 is mounted on one end (the left end as viewed in FIG. 2) of the valve housing 21. The actuator 30 drives the valve shaft 24. In this embodiment, the actuator 30 comprises a rotary solenoid actuator. A coil 33 is wound around which a core 32 and both are disposed within a housing 31 of the actuator 30.

The housing 31 of the actuator 30 is fitted into the left end of the valve housing 21 via an O-ring 34. A magnet 26 is mounted on the left end of the valve shaft 24. A spring washer 35 is disposed between the housing 31 of the actuator 30 and the opposing bearing 27.

A cap 29 is press-fitted into the other end (the right end as viewed in FIG. 2) of the valve housing 21. A flat washer 36 is disposed between the cap 29 and the opposing bearing 28.

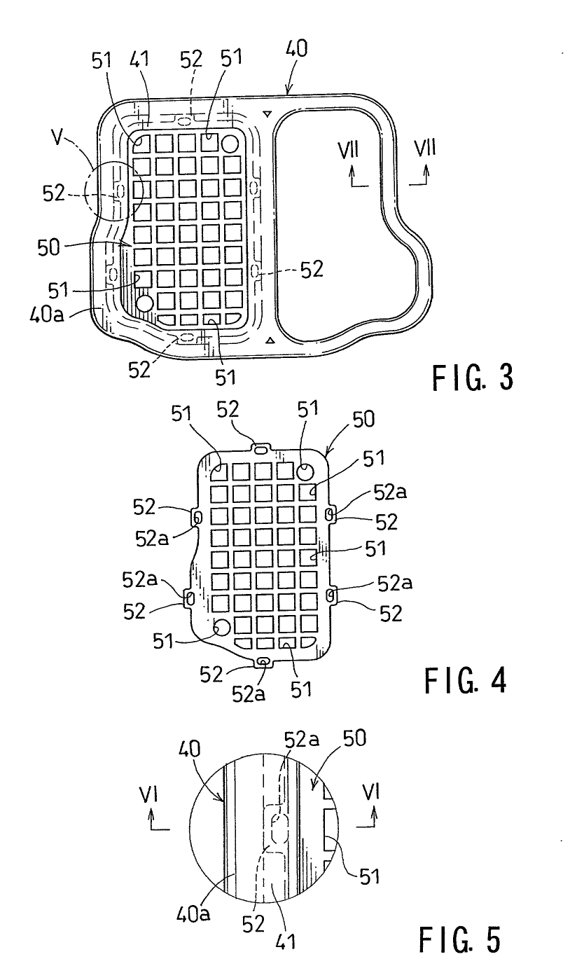

FIG. 3 is a plan view of the gasket 40 that seals the clearance between the throttle body 10 and the valve housing 21. As mentioned above, the gasket 40 is generally figure-8 shaped. The gasket 40 has a basically circular cross-section as shown in FIG. 7, which is a sectional view taken along line VII-VII in FIG. 3. As shown in FIG. 9, the gasket 40 is fitted into the groove 15 of the throttle body 10. The gasket 40 elastically deforms into a generally elliptic shape in cross-section when the valve housing 21 of the idle speed control device 20 is joined to the throttle body 10. As a result, the clearance between the throttle body 10 and the valve housing 21 is sealed.

The gasket 40 has an annular portion 40a that surrounds the joining side passage 13b of the throttle body 10. A lattice 50 is disposed on the annular portion 40a and closes the opening of the annular portion 40a.

In this embodiment, the lattice 50 comprises stainless steel that has been formed into a lattice or grid structure. Specifically, as shown in FIG. 4, the lattice 10 is formed by introducing several rectangular air holes 51 in a generally rectangular stainless steel plate.

As shown in FIG. 4, the air holes 51 that are located in an upper right corner and a lower left corner of the lattice 50 are circular. Further, some of the air holes 51 that are located in the outer peripheral portion of the lattice 50 have a generally triangular or trapezoidal shape so as to correspond to the contour of the annular portion 40a of the gasket 40.

A plurality of projections 52 is formed on the outer peripheral edge of the lattice 50. In FIG. 4, a total of six projections 52 are shown and one projection 52 is disposed on each on the upper and lower edges and two each on the right and left edges of the lattice 50. Each of the projections 52 has a through hole 52a.

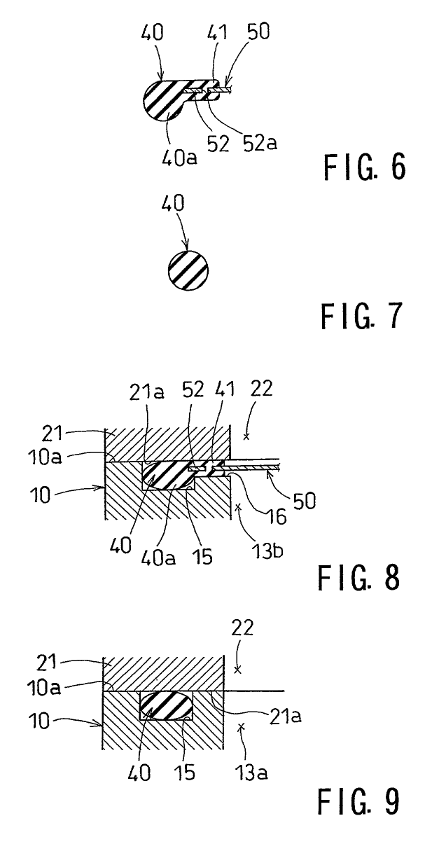

Further, as shown in FIG. 3, a support piece 41 is integrally formed on and along the inner peripheral portion of the annular portion 40a of the gasket 40. FIG. 5 is a partially enlarged view of circled portion V in FIG. 3 and FIG. 6 is a sectional view taken along line VI-VI in FIG. 5.

As shown in FIG. 6, the support piece 41 of the annular portion 40a of the gasket 40 projects in the tangential direction of the section of the annular portion 40a with a predetermined thickness and a predetermined length of projection. The outer peripheral 30 edge portion of the lattice 50 including the projections 52 is integrally formed with the support piece 41 by insert molding. Thus, the support piece 41 supports the projections 52 of the lattice 50. As shown in FIG. 6, the support piece 41 is formed in a manner that the outer peripheral edge portion of the lattice 50 is inserted into the support piece 41. An elastic rubber material is filled in the through holes 52a of the projections 52. Thus, the outer peripheral edge portion of the lattice 50 is securely supported by the support piece 41.

As shown in FIG. 8, the annular portion 40a of the gasket 40 is fitted into the outer peripheral portion of the groove 15 that surrounds the joining side passage 13b of the throttle body 10. The gasket 40 elastically deforms into a generally elliptical shape in cross-section when the valve housing 21 of the idle speed control device 20 is joined to the throttle body 10. As a result, the clearance between the throttle body 10 and the valve housing 21 is sealed.

A stepped surface 16 is formed on and along the inner peripheral portion of the groove 15 that receives the annular portion 40a of the gasket 40. The depth of the stepped surface 16 from the joining surface 10a is about the half of the depth of the outer peripheral portion of the groove 15 from the joining surface 10a. Thus, the support piece 41 of the annular portion 40a of the gasket 40 is held between the stepped surface 16 and the joining surface 21a of the valve housing 21 by a light pressing force.

The lattice 50 is disposed downstream of the valve seat portion 23 of the idle speed control device 20 by disposing the gasket 40 between the valve housing 21 and the throttle body 10 in a manner as described above.

The operation of the idle speed control device 20 will now be explained. When the coil 33 of the actuator 30 is energized while the internal combustion engine is idling, the magnet 26 pivots. As a result, the valve 25 pivots together with the valve shaft 24. The cross-sectional area (opening area) of the passage of the valve seat portion 23 of the valve housing 21 is changed by pivoting the valve 25. Thus, the airflow rate that is supplied into the combustion chamber of the internal combustion engine through the bypass structure 13 is controlled.

Air that has passed through the valve seat portion 23 of the valve housing 21 passes through the air holes 51 of the lattice 50 and flows through the joining side passage 13b of the throttle body 10 (in the direction shown by arrow Y2 in FIG. 1). Thus, the air flowing through the bypass structure 13 is diffused by passing through the lattice 50 immediately after having passed through the valve seat portion 23. As a result, generation of turbulence can be reduced or prevented, and thus noises that are caused by generation of turbulence can be reduced.

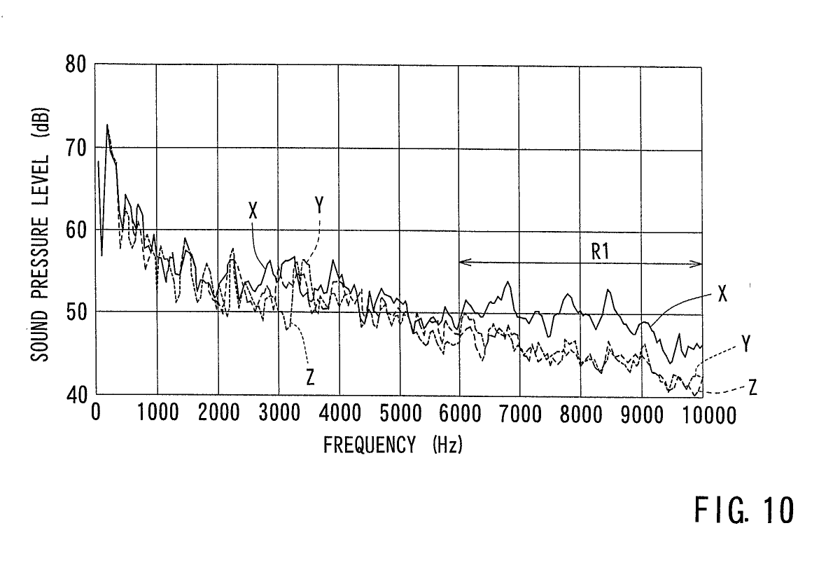

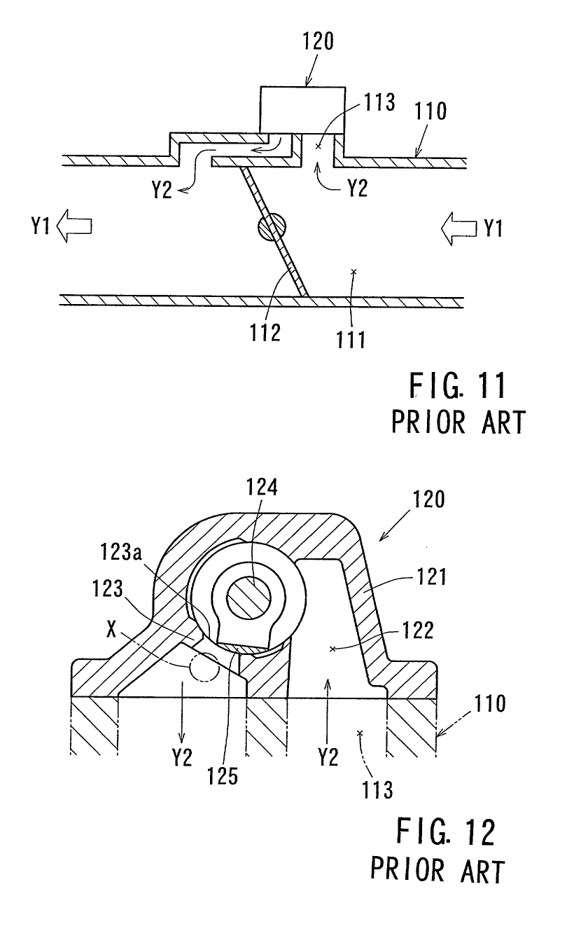

In order to test these structures, the sound pressure level for two representative examples of the present teachings and one comparative example were measured. The two representative examples included a lattice 50 having a lattice width of 2 mm and 2.5 mm, respectively. A lattice 50 was not provided in the comparative example. The measurement results are shown in FIG. 10.

FIG. 10 shows the sound pressure level that was measured 30 cm above the intake manifold of the internal combustion engine. In FIG. 10, the abscissa represents the sound frequency (Hz) and the ordinate represents the sound pressure level (dB). Solid line X represents the sound pressure level of the comparative example. Dotted line Y represents the sound pressure level of the representative example having the lattice 50 with a lattice width of 2 mm. Long-dotted line Z represents the sound pressure level of the representative example having the lattice 50 with a lattice width of 2.5 mm.

Hissing noises are caused by frequencies over 6000 Hz. As it will be clearly seen from FIG. 10, sound pressure levels Y and Z over 6000 Hz are lower when the lattice is used than sound pressure level X when the lattice is not used. Therefore, these experiments confirmed that noises can be reduced by disposing the lattice 50 downstream of the valve seat portion 23.

In this embodiment, the valve housing 21 is joined to the throttle body 10 in the state in which the lattice 50 is disposed between the throttle body 10 and the valve housing 21. Therefore, because the lattice 50 can be installed by utilizing the throttle body 10 and the valve housing 21, a special component for installing the lattice 50 is not required.

Further, in this embodiment, the lattice 50 is integrally formed with the gasket 40 that is disposed between the throttle body 10 and the valve housing 21. Therefore, the lattice 50 can be installed together with the gasket 40 at the same time.

The present invention is not limited to the constructions that have been described as the representative embodiments, but rather, may be added to, changed, replaced with alternatives or otherwise modified without departing from the spirit and scope of the invention. For example, while lattice 50 has been described as being disposed between the throttle body 10 and the valve housing 21, the lattice 50 may be integrally formed with the valve housing 21. Further, the air holes 51 may be of a circular, triangular, pentagonal, hexagonal, slit-like or similar shape (i.e. shapes other than rectangle may be used). Further, the lattice 50 may comprise punched metal, wire gauze, resin or similar materials.

Although the lattice 50 has been described as being integrally formed with the gasket 40 which is disposed between the throttle body 10 and the valve housing 21, the lattice 50 may be directly disposed between the throttle body 10 and the valve housing 21. Further, the method of integrally forming the lattice 50 with the gasket 40 is not limited to the method described in the representative embodiment. In addition, the groove 15 for receiving the annular portion 40a of the gasket 40 may be formed in the valve housing 21.

Although the valve housing 21 has been described as being formed as a separate body from the throttle body 10, the valve housing 21 may be integrally formed with the throttle body 10. Further, a mechanism for driving the valve 25 of the idle speed control device 20 is not limited to the rotary solenoid actuator 30 described in the representative embodiment, and various other mechanisms, such as a direct-acting solenoid actuator, may be used.

Finally, various structures may be utilized to reduce turbulent airflow or in fact, provide a laminar airflow from the idle speed control device. For example, fins may be utilized instead of, or in addition to, the lattice described above. A person of skill in the art will recognize other useful structures for performing this function.

What is claimed is:

1. An apparatus adapted to bypass a throttle valve and supply air to an internal combustion engine while the engine is idling, comprising:
a bypass passage,
a valve disposed within the bypass passage,
a valve seat disposed within the bypass passage and adapted to contact the valve, wherein the valve controls an opening area of the valve seat and
means for producing a laminar air flow downstream of the opening area of the valve seat.

2. An apparatus as in claim 1, wherein the means for producing a laminar air flow is a lattice member that is disposed downstream of the valve seat.

3. An apparatus as in claim 2, wherein a gasket is integrally formed with an outer peripheral edge portion of the lattice and a plurality of projections is formed on the outer peripheral edge portion of the lattice, each projection having a through hole.

4. An apparatus as in claim 3, wherein the gasket has an annular portion that is adapted to fit within a groove formed in either one of the throttle body or a valve housing.

5. An apparatus as in claim 4, wherein a support piece is formed on and along an inner periphery of the annular portion of the gasket and the support piece is adapted to contact a stepped surface formed on and along an inner peripheral portion of the groove in either one of the throttle body or the valve housing.

6. An idle speed control device adapted to bypass a throttle valve and supply air to an internal combustion engine, comprising:
a bypass passage,
a valve disposed within the bypass passage, a valve seat disposed within the bypass passage and adapted to contact the valve, wherein the valve controls an opening area of the valve seat and
means for reducing turbulent airflow from the bypass passage to the internal combustion engine.

7. An idle speed control device as in claim 6, wherein the means for reducing turbulent air flow is a lattice member that is disposed downstream of the valve seat.

8. An apparatus as in claim 7, wherein a gasket is integrally formed with an outer peripheral edge portion of the lattice and a plurality of projections is formed on the outer peripheral edge portion of the lattice, each projection having a through hole.

9. An apparatus as in claim 8, wherein the gasket has an annular portion that is adapted to fit within a groove formed in either one of the throttle body or a valve housing.

10. An apparatus as in claim 9, wherein a support piece is formed on and along an inner periphery of the annular portion of the gasket and the support piece is adapted to contact a stepped surface formed on and along an inner peripheral portion of the groove in either one of the throttle body or the valve housing.

11. An idle speed control device having a bypass structure adapted to bypass a throule valve, which throttle valve is provided in an intake air passage through which air is supplied into a combustion chamber of an internal combustion engine, a valve seat portion provided in the bypass structure, and a valve for controlling an opening area of the valve seat portion, wherein:
a lattice is disposed downstream of the valve seat portion.

12. An apparatus comprising the idle speed control device of claim 11, a throttle body and a valve housing, wherein the throttle valve is disposed in the throttle body and the valve is disposed in the valve housing, wherein the valve housing is joined to the throttle body, and wherein the lattice is disposed between the throttle body and the valve housing.

13. An apparatus comprising the idle speed control device of claim 11, a throttle body and a valve housing, wherein the throttle valve is disposed in the throttle body and the valve is disposed in the valve housing, wherein the valve housing is joined to the throttle body, and wherein a gasket is disposed between the throttle body and the valve housing and the lattice is integrally formed with the gasket.

14. An apparatus as in claim 13, wherein the throttle body has a branching side passage and a joining side passage and the valve housing has a communication passage that permits the branching side passage to communicate with the joining side passage, and wherein the gasket has a generally figure-8 shape and the lattice is integrally formed on a portion of the gasket that faces the joining side passage.

15. An apparatus as in claim 13, wherein an outer peripheral edge portion of the lattice is integrally formed with the gasket, and wherein a plurality of projections is formed on the outer peripheral edge portion of the lattice, each projection having a through hole.

16. An apparatus as in claim 13, wherein the gasket has an annular portion, and wherein a groove is formed in either one of the throttle body or the valve housing and receives the annular portion of the gasket.

17. An apparatus as in claim 16, wherein a support piece is formed on and along an inner periphery of the annular portion of the gasket, and wherein a stepped surface is formed on and along an inner peripheral portion of the groove in the either one of the throttle body or the valve housing and the stepped surface contacts the support piece.
